(19) United States
(12) Patent Application Publication
(10) Pub. No.: US 2013/0242127 A1
(43) Pub. Date: Sep. 19, 2013

(54) IMAGE CREATING DEVICE AND IMAGE CREATING METHOD

(71) Applicant: CASIO COMPUTER CO., LTD., Tokyo (JP)

(72) Inventors: Hirokiyo KASAHARA, Tokyo (JP); Shigeru KAFUKU, Tokyo (JP); Keisuke SHIMADA, Tokyo (JP)

(73) Assignee: CASIO COMPUTER CO., LTD., Tokyo (JP)

(21) Appl. No.: 13/796,615

(22) Filed: Mar. 12, 2013

(30) Foreign Application Priority Data
Mar. 19, 2012 (JP) 2012-061686

(51) Int. Cl. H04N 5/232

(52) U.S. Cl. CPC H04N 5/23219
USPC 348/222.1

(57) ABSTRACT

An image creating device includes: an acquiring unit for acquiring an image; an extracting unit for extracting feature information from a face in the image acquired by the acquiring unit; and a creating unit for creating a replaced image by replacing an image of a face region in the image acquired by the acquiring unit by other image, based on the feature information extracted by the extracting unit.

### 1. FIELD OF THE INVENTION

This invention relates to an image creating device and an image creating method.

### 2. DESCRIPTION OF THE RELATED ART

Heretofore, a technique is known, in which faces of people other than those of specific people in a captured image are treated with pixelization or blurring, from the aspect of privacy protection (Patent Document 1: Japanese Unexamined Patent Application Publication No. 2010-021921).

However, as in the above mentioned Patent Document 1, when the image is treated with pixelization or blurring, the image becomes unnatural in overall appearance. Further, a method may be used in which each of face regions is simply replaced with another image; however, consistency of the face before and after the replacement may not be maintained when the face region is replaced with another image.

### BRIEF SUMMARY OF THE INVENTION

The present invention aims to provide an image creating device capable of creating a natural replaced image while keeping privacy, and an image creating method.

According to a first aspect of an embodiment of the present invention, there is provided an image creating device comprising:

an acquiring unit for acquiring an image;

an extracting unit for extracting feature information from a face in the image acquired by the acquiring unit; and

a creating unit for creating a replaced image by replacing an image of a face region in the image acquired by the acquiring unit by other image, based on the feature information extracted by the extracting unit.

According to a second aspect of an embodiment of the present invention, there is provided an image creating method, which uses an image creating device, including:

an acquiring step for acquiring an image;

an extracting step for extracting feature information from a face in the acquired image; and

a creating step for creating a replaced image by replacing an image of a face region in the acquired image by other image, based on the extracted feature information.

### BRIEF DESCRIPTION OF THE SEVERAL VIEWS OF THE DRAWING

FIG. 1 is a view showing a schematic configuration of an image capturing system according to an embodiment of the present invention.

FIG. 2 is a block diagram showing a schematic configuration of an image capturing device configuring the image capturing system in FIG. 1.

FIG. 3A is a view schematically showing an example of a face image for replacement stored in the image capturing device in FIG. 2.

FIG. 3B is a view schematically showing an example of a face image for replacement stored in the image capturing device in FIG. 2.

FIG. 3C is a view schematically showing an example of a face image for replacement stored in the image capturing device in FIG. 2.

FIG. 4 is a flowchart showing an example of an operation according to an image creating process performed by the image capturing device in FIG. 2.

FIG. 5 is a view schematically showing an original image according to the image creating process in FIG. 4.

FIG. 6A is a view schematically showing an example of an image according to the image creating process in FIG. 4.

FIG. 6B is a view schematically showing an example of an image according to the image creating process in FIG. 4.

FIG. 7 is a view schematically showing an example of a replaced image according to the image creating process in FIG. 4.

FIG. 8 is a block diagram showing a schematic configuration of an image capturing device according to a modification example 1.

### DETAILED DESCRIPTION OF THE INVENTION

Hereinafter, an embodiment of the present invention is described in detail with reference to the drawings. However, the scope of the present invention is not limited to the illustrated examples.

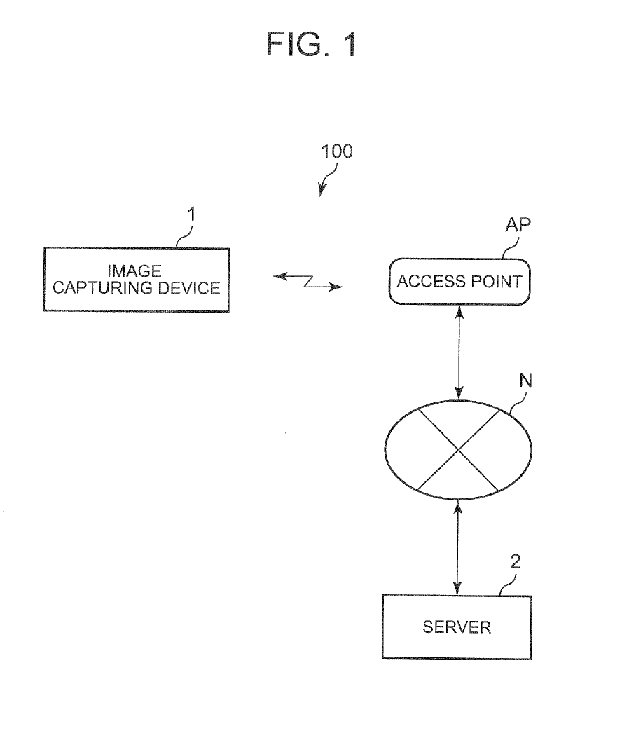

FIG. 1 is a view illustrating a schematic configuration of an image capturing system 100 according to an embodiment of the present invention.

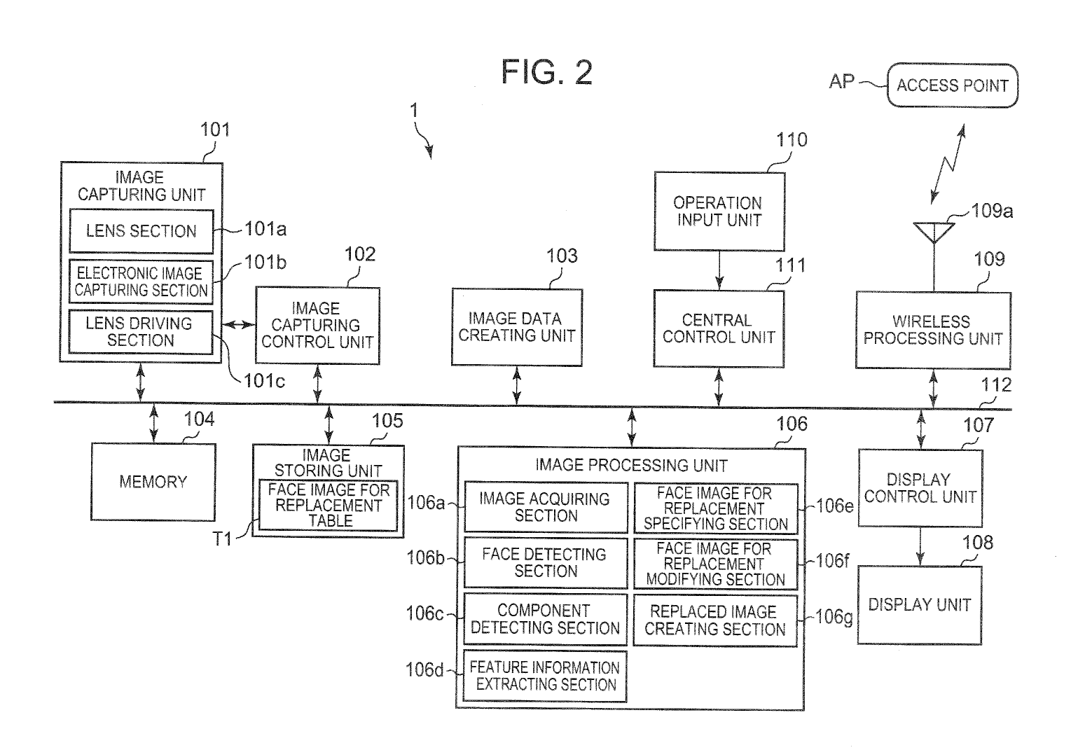

As shown in FIG. 1, the image capturing system 100 of this embodiment includes an image capturing device 1 (refer to FIG. 2) and a server 2. The image capturing device 1 and the server 2 are connected via an access point AP and a communication network N, so that mutual information communication between the two is possible.

First, an explanation is made on the server 2.

The server 2 is configured to include, for example, an external storage device registered by a user in advance. In other words, the server 2 is composed of, for example, contents servers and the like that can put image data uploaded via the communication network N on the Internet, and stores the uploaded image data.

Specifically, the server 2 includes, although not shown, for example, a central control unit for controlling respective units of the server 2, a communication processing unit for communicating information with external devices (such as the image capturing device 1), and an image storing unit for storing image data sent from the external devices.

Next, the image capturing device 1 is explained with reference to FIG. 2.

FIG. 2 is a block diagram showing a schematic configuration of the image capturing device 1 configuring the image capturing system 100.

As shown in FIG. 2, specifically, the image capturing device 1 includes an image capturing unit 101, an image capturing control unit 102, an image data creating unit 103, a memory 104, an image storing unit 105, an image processing unit 106, a display control unit 107, a display unit 108, a wireless processing unit 109, an operation input unit 110 and a central control unit 111.

Further, the image capturing unit 101, the image capturing control unit 102, the image data creating unit 103, the memory 104, the image storing unit 105, the image processing unit 106, the display control unit 107, the wireless processing unit 109 and the central control unit 111 are connected via a bus line 112.

The image capturing unit 101 captures a predetermined subject and creates a frame image.

Specifically, the image capturing unit 101 includes a lens section 101a, an electronic image capturing section 101b and a lens driving section 101c.

The lens section 101a includes, for example, a plurality of lenses such as zoom lens and focus lens.

The electronic image capturing section 101b includes, for example, image sensors (image capturing elements) such as charge coupled devices (CCD) and complementary metal-oxide semiconductors (CMOS). The electronic image capturing section 101b converts an optical image transmitted through various lenses of the lens section 101a into two-dimensional image signals.

Although not shown, the lens driving section 101c includes, for example, a zoom driving unit for moving the zoom lens into an optical axis direction, a focusing driving unit for moving the focus lens into the optical axis direction, and the like.

In addition, the image capturing unit 101 may include a not-shown diaphragm for adjusting an amount of light transmitted through the lens section 101a, as well as the lens section 101a, the electronic image capturing section 101b and the lens driving section 101c.

The image capturing control unit 102 controls capturing of a subject by the image capturing unit 101. In other words, the image capturing control unit 102 includes, although not shown, a timing generator, a driver and the like. The image capturing control unit 102 scan-drives the electronic image capturing section 101b using the timing generator, the driver and the like, converts an optical image transmitted through the lens section 101a at the electronic image capturing section 101b into two-dimensional image signals for every predetermined period, reads out frame images one-by-one from an image capturing region of the electronic image capturing section 101b, and outputs the read out frame images to the image data creating unit 103.

In addition, the image capturing control unit 102 may adjust a focusing position of the lens section 101a by moving the electronic image capturing section 101b in the optical axis direction instead of moving the focus lenses of the lens section 101a.

Also, the image capturing control unit 102 may control adjustment of conditions upon capturing the subject such as auto focus (AF), auto exposure (AE) and auto white balance (AWB).

The image data creating unit 103 appropriately adjusts a gain of an analog signal of a frame image transferred from the electronic image capturing section 101b for respective RGB color components, then performs sampling and holding with a sample/hold circuit (not shown) for the analog signal to convert the same with an A/D converter (not shown) into a digital signal, performs color processing including a pixel interpolation process and a gamma correction process with a color processing circuit (not shown), and creates a luminance signal Y and color-difference signals Cb and Cr (YUV data) having digital values.

The luminance signal Y and the color-difference signals Cb and Cr outputted from the color processing circuit are DMA-transferred to the memory 104 used as a buffer memory via a not-shown DMA controller.

The memory 104 is composed of, for example, a dynamic random access memory (DRAM) or the like, and temporarily stores data and the like processed at the central control unit 111 and the other respective units of the image capturing device 1.

The image storing unit 105 is composed of, for example, a non-volatile memory (flash memory) or the like, and stores image data for storing after the image data is encoded into a predetermined compression format (e.g., JPEG format and the like) at an encoding unit (not shown) of the image processing unit 106.

Also, the image storing unit 105 has a predetermined number of pieces of image data for a face image F for replacement stored in a face image for replacement table T1 after the image data is associated with face feature information.

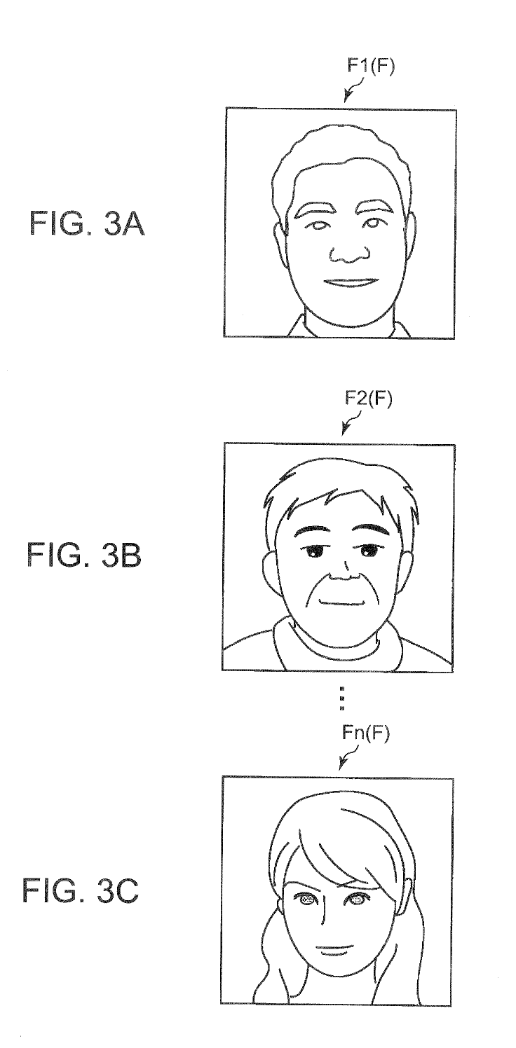

Each piece of the image data for the face images F1 to Fn for replacement is an image that corresponds to, for example, as shown in FIGS. 3A to 3C and the like, a face region included in a face extracted from the image.

The face feature information is an information regarding principal face components (such as eyes, nose, mouth, eyebrows and facial contour) of a face extracted from each face image F for replacement, and includes positional information associated with a coordinate position (x,y) in an x-y plane of pixels forming each face component. In addition, facial contour and eyes, nose, mouth, eyebrows and the like present inside the facial contour are detected as the principal face components by, for example, performing a process (described later) by applying an active appearance model (AAM) to the face region extracted from each face image F for replacement.

Moreover, the image storing unit 105 may have a configuration in which, for example, a storage medium (not shown) is detachably attached thereto and reading/writing of data to/from the attached storage medium is controlled.

Here, the face images F1 to Fn for replacement illustrated in FIGS. 3A to 3C are only examples. The images are not limited thereto but can be changed accordingly.

The image processing unit 106 includes an image acquiring section 106a, a face detecting section 106b, a component detecting section 106c, a feature information extracting section 106d, a face image for replacement specifying section 106e, a face image for replacement modifying section 106f and a replaced image creating section 106g.

In addition, each unit in the image processing unit 106 is composed of, for example, a predetermined logic circuit; however, the configuration is only an example and not limited thereto.

The image acquiring section 106a acquires an image to be processed through an image creating process (described later).

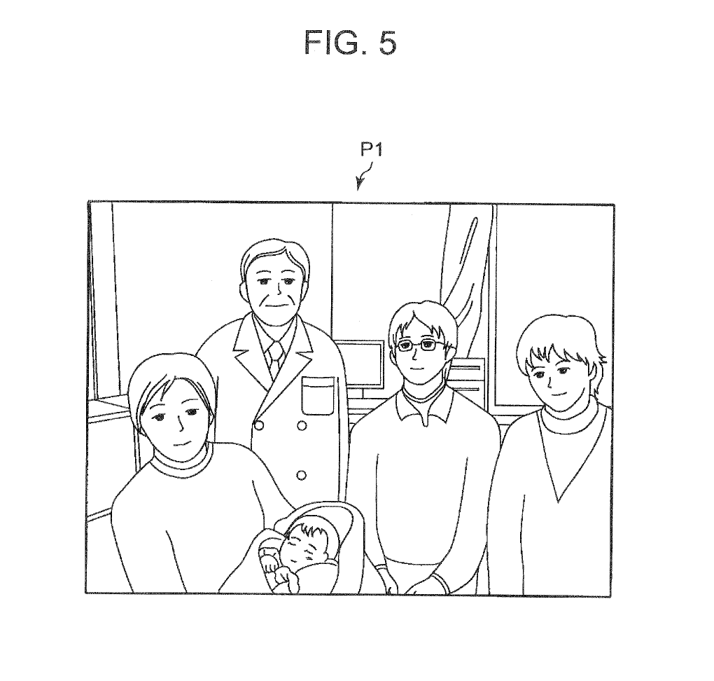

In other words, the image acquiring section 106a acquires image data of an original image P1 (such as a photographic image). Specifically, the image acquiring section 106a acquires a copy of the image data (YUV data) created by the image data creating unit 103 from the original image P1 of a subject captured by the image capturing unit 101 and the image capturing control unit 102, and acquires a copy of the image data (YUV data) for the original image P1 stored in the image storing unit 105 (see FIG. 5).

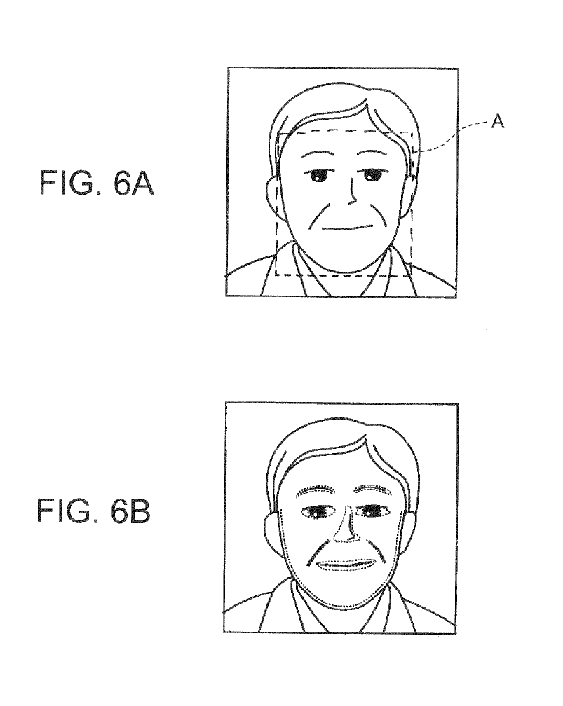

The face detecting section 106b detects a face region A (see FIG. 6A) from the original image P1 to be processed.

In other words, the face detecting section 106b detects the face region A including a face from the original image P1 acquired by the image acquiring section 106a. Specifically, the face detecting section 106b acquires the image data of the original image P1 acquired by the image acquiring section 106a as an image to be processed through the image creating process, and detects the face region A after performing a predetermined face detection process to the image data.

Here, the face detection process is a publicly known technique; therefore, a detailed description is omitted.

Further, in each of FIG. 6A and later described FIG. 6B, only a portion including the face region A detected from the original image P1 is schematically shown in an enlarged manner.

The component detecting section 106c detects principal face components from the original image P1.

In other words, the component detecting section 106c detects principal face components from the face in the original image P1 acquired by the image acquiring section 106a. Specifically, the component detecting section 106c detects the face components such as facial contour and eyes, nose, mouth and eyebrows present inside the facial contour by, for example, performing the process by applying the AAM to the face region A detected by the face detecting section 106b from the image data of the original image P1 (see FIG. 6B).

Further, in FIG. 6B, the principal face components detected from the face of the original image P1 are shown schematically by dotted lines.

Here, the AAM is a technique for modeling a visual phenomenon and is a process for modeling an image of an arbitral face region. For example, in a plurality of sample face images, statistical result of analysis of positions and pixel values (for example, luminance) of predetermined feature components such as a tail of an eye, a tip of a nose, and a face line are registered in predetermined registration unit (for example, a predetermined storage region in storage unit). Then, the component detecting section 106c sets a shape model representing a face shape and a texture model representing “Appearance” in an average shape by using the positions of the feature components as reference, and performs modeling of the image of the face region A by using the above models. By this, the component detecting section 106c extracts the principal face components in the original image P1.

Further, the process by applying the AAM is exemplified for the detection of the face components; however, this is only an example and the process is not limited thereto, and for example, an active shape model (ASM) may also be applied. As the ASM is a publicly known technique, a detailed description is omitted.

The feature information extracting section 106d extracts feature information from the original image P1.

In other words, the feature information extracting section 106d extracts the feature information from the face of the original image P1 acquired by the image acquiring section 106a. Specifically, the feature information extracting section 106d extracts, for example, the feature information of the face components such as facial contour, eyes, nose, mouth and eyebrows detected from the original image P1 by the component detecting section 106c. More specifically, the feature information extracting section 106d extracts, for example, the feature information of the respective face components detected by the component detecting section 106c from the face region A detected by the face detecting section 106b.

Here, the feature information is information related to the principal face components of the face extracted from the original image P1, and includes, for example, positional information associated with coordinate positions (x,y) in an x-y plane for pixels forming each face component, and positional information associated with relative positional relationships in the x-y plane between the pixels forming the respective face components, and so on.

Further, the exemplified feature information is only an example and not limited thereto, and can be changed accordingly. For example, the feature information may include colors of skin, hair, eyes and the like.

The face image for replacement specifying section 106e specifies a face image F for replacement that corresponds to the feature information extracted by the feature information extracting section 106d.

In other words, the face image for replacement specifying section 106e specifies the face image F for replacement that corresponds to the feature information extracted by the feature information extracting section 106d, based on the face feature information stored in the image storing unit 105. Specifically, the face image for replacement specifying section 106e compares respective pieces of the feature information for a predetermined number of the face images F for replacement, which is stored in the face image for replacement table T1 in the image storing unit 105, with respective pieces of the feature information extracted from the face region A of the original image P1 by the feature information extracting section 106d, and calculates matching degrees of the face components thereof with each other for the respective face images F for replacement (for example, an L2 norm, which is the shortest distance between coordinate positions of pixels configuring each of the corresponding face components, or the like). Thereafter, the face image for replacement specifying section 106e specifies image data of the face image F for replacement (for example, the face image F2 for replacement or the like) that corresponds to the feature information of which the calculated matching degree becomes the highest.

Here, the face image for replacement specifying section 106e may specify a plurality of face images F for replacement associated with the feature information having the higher matching degrees than a predetermined value, and from among the specified plurality of face images F for replacement, may specify the one selected as desired by a user based on a predetermined operation of the operation input unit 110 by the user.

In addition, it is preferable that the face image F for replacement stored in the face image for replacement table T1 and the face region A of the original image P1 are set to have similar sizes (pixels) in horizontal and vertical directions in prior to the specifying of the face image F for replacement corresponding to the face feature information in the original image P1.

The face image for replacement modifying section 106f performs a modification process of the face image F for replacement.

In other words, the face image for replacement modifying section 106f modifies the face image stored in the image storing unit 105 based on the feature information of the face components extracted by the feature information extracting section 106d. Specifically, the face image for replacement modifying section 106f modifies the face image F for replacement for replacing the face region A of the original image P1, that is, the face image F for replacement specified by the face image for replacement specifying section 106e, based on the feature information of the face components extracted from the face region A of the original image P1 by the feature information extracting section 106d, and creates image data for the modified face image F for replacement.

For example, the face image for replacement modifying section 106f sets coordinate positions of pixels configuring respective face components as target coordinate positions after modification. Then, deformation, rotation, scaling, tilting and curving are performed on the face image F for replacement, so as to move the coordinate positions of the pixels configuring each of the corresponding face components of the face image F for replacement.

Here, the modification process is a publicly known technique; therefore, a detailed description is omitted.

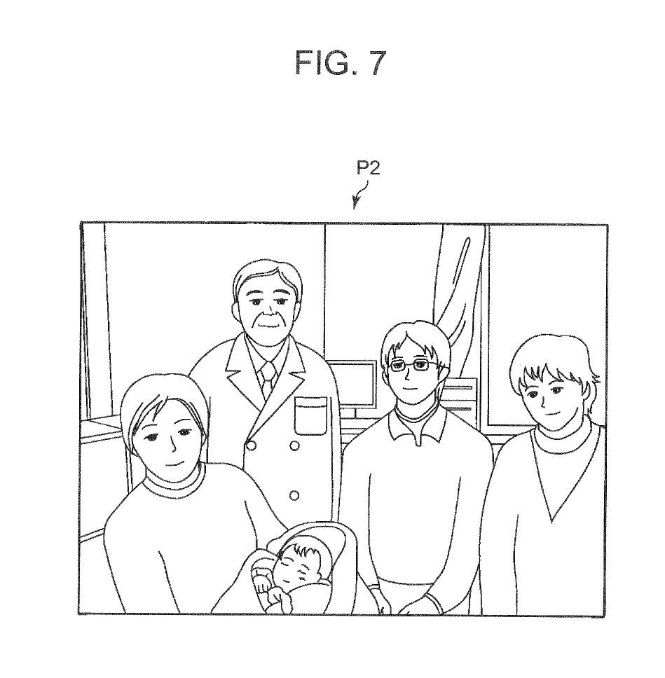

The replaced image creating section 106g creates a replaced image P2 (refer to FIG. 7) in which the face region A in the original image P1 is replaced by the face image F for replacement.

In other words, the replaced image creating section 106g creates the replaced image P2 in which an image of the face region A in the original image P1 acquired by the image acquiring section 106a is replaced by any one of the face images F for replacement stored in the image storing unit 105, based on feature information extracted by the feature information extracting section 106d and face feature information stored in the image storing unit 105. Specifically, the replaced image creating section 106g creates the image data of the replaced image P2 by replacing the image of the face region A in the original image P1 by the modified face image F for replacement being modified by the face image for replacement modifying section 106f.

For example, the replaced image creating section 106g performs replacement so that a position corresponding to a predetermined position of the modified face image F for replacement is matched with a predetermined position of the image of the face region A in the original image P1 (for example, four corners). At this time, the replaced image creating section 106g may, for example, replace a portion from the neck up of the face region A in the original image P1 with a portion from the neck up of the modified face image F for replacement, or, may replace an inner portion of the facial contour of the face region A in the original image P1 with an inner portion of the facial contour of the modified face image F for replacement. Further, the replaced image creating section 106g may replace only a part of face components of the face region A in the original image P1 with corresponding face components of the modified face image F for replacement.

Moreover, the replaced image creating section 106g may adjust color tone so that color of the face image F for replacement matches with color of a region other than the face image F for replacement in the replaced image P2, that is, so as not to bring a feeling of strangeness due to color differences between replaced region and the other regions.

Also, when the face image for replacement 106f does not perform the modification of the face image F for replacement, the replaced image creating section 106g may create the replaced image P2 by replacing the image of the face region A in the original image P1 with the face image F for replacement which is specified by the face image for replacement specifying section 106e. Here, a specific process for replacing an image with the face image F for replacement is the same as the above process in which the modified face image F for replacement is used, so the description is omitted.

In other words, the image capturing device 1 does not necessarily create the modified face image F for replacement by the face image for replacement modifying section 106f, and the face image for replacement modifying section 106f can be arbitrarily changed to be included or not to be included.

The display control unit 107 controls to read out image data for display stored temporarily in the memory 104 and to make the display unit 108 display the same.

Specifically, the display control unit 107 includes a video random access memory (VRAM), a VRAM controller, a digital video encoder, and the like. Then, under the control of the central control unit 111, the digital video encoder periodically reads out from the VRAM (not shown) via the VRAM controller the luminance signal Y and the color-difference signals Cb and Cr read out from the memory 104 and stored in the VRAM, generates video signals based on the data and outputs the same to the display unit 108.

The display unit 108 is, for example, a liquid crystal display panel, and displays images and the like captured by the image capturing unit 101 on a display screen based on a video signal from the display control unit 107. Specifically, the display unit 108 displays live view images while successively updating, at a predetermined frame rate, a plurality of frame images generated by capturing of a subject with the image capturing unit 101 and the image capturing control unit 102 in a static image capturing mode or a moving image capturing mode. Also, the display unit 108 displays images recorded as still images (Rec View images) and images being recorded as moving images.

The wireless processing unit 109 performs a predetermined wireless communication with the access point AP to control communication of information with external devices such as the server 2 connected thereto via the communication network N.

In other words, the wireless processing unit 109 configures a wireless communicating unit for communication via a predetermined communication line and includes, for example, a wireless LAN module having a communication antenna 109a. Specifically, the wireless processing unit 109 transmits from the communication antenna 109a, image data of the replaced image P2 via the access point AP and the communication network N to the server 2.

In addition, the wireless processing unit 109 may be configured to be built-in inside a not-shown storage medium, or to be connected to the image capturing device itself via a predetermined interface (such as a universal serial bus (USB) and the like).

Furthermore, the communication network N is a communication network constructed by using, for example, an exclusive line or an existing general public line, and various line forms such as a local area network (LAN) and a wide area network (WAN) can be applied thereto. Also, the communication network N includes various communication networks such as a telephone network, an Integrated Services Digital Network (ISDN), an exclusive line, a mobile network, a communication satellite connection and a Community Antenna Television (CATV) network, and an Internet Service Provider and the like connecting the above communication networks.

The operation input unit 110 is provided to perform predetermined operations of the image capturing device 1. Specifically, the operation input unit 110 includes operation sections such as a shutter button related to an instruction for capturing a subject image, a select/enter button related to an instruction for selecting an image capturing mode or a function, a zoom button related to an instruction for adjusting a zoom amount (all of the above not shown), and outputs a predetermined operation signal to the central control unit 111 according to an operation of each button in the operation sections.

The central control unit 111 is provided to control respective units in the image capturing device 1. Specifically, the central control unit 111 includes, for example, a central processing unit (CPU) (not shown) and the like, and performs various control operations according to various processing programs (not shown) for the image capturing device 1.

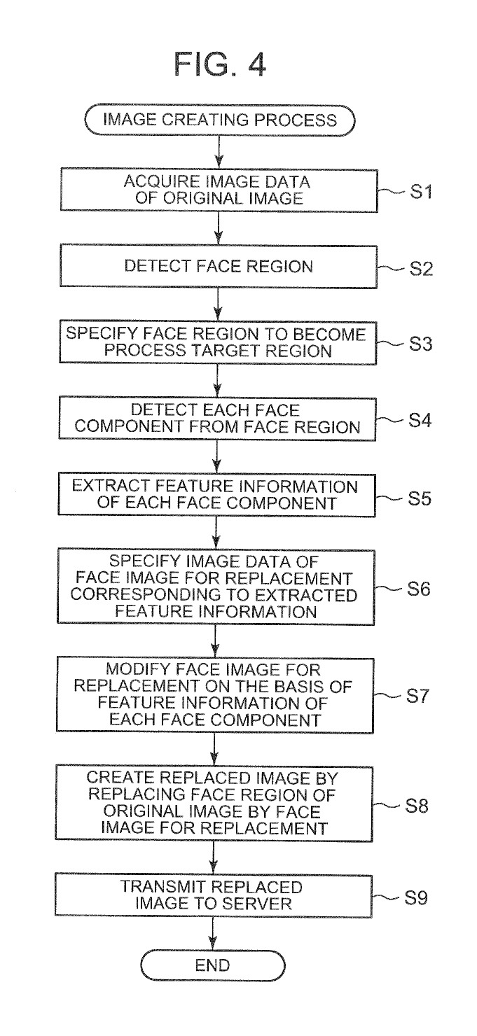

Next, image creating process by the image capturing device 1 is described with reference to FIGS. 4 to 7. FIG. 4 is a flowchart showing an example of an operation according to the image creating process.

The image creating process is a process executed by respective units, particularly by the image processing unit 106, of the image capturing device 1 under the control of the central control unit 111, when a replaced image creating mode is selected from among a plurality of operation modes displayed on a menu screen according to a predetermined operation at the operation input unit 110 by a user.

In addition, it is assumed that: image data of an original image P1 to be processed through the image creating process is stored in the image storing unit 105; and a predetermined number of pieces of image data of face images F for replacement is associated with face feature information and is stored in the image storing unit 105.

As shown in FIG. 4, first, the image storing unit 105 reads out image data of the original image P1 (see FIG. 5) specified based on the predetermined operation at the operation input unit 110 by the user, from among image data stored in the image storing unit 105. Then, the image acquiring section 106a of the image processing unit 106 acquires the read out image data as a process target of the image creating process (step S1).

Next, the face detecting section 106b performs a predetermined face detection process to the image data of the original image P1 acquired by the image acquiring section 106a as the process target, and detects a face region A (step S2). For example, in a case of using an original image P1 as illustrated in FIG. 5, face regions A for four people and a baby are respectively detected.

Then, the image processing unit 106 specifies the face region A as a target process region, which is selected based on the predetermined operation at the operation input unit 110 by the user from among the detected face regions A (step S3). For example, in this embodiment, the following respective process steps are performed by assuming that the face region A (see FIG. 6A) of a man with a white coat standing at the backmost position is specified as the target process region.

Subsequently, the component detecting section 106c performs the process by applying the AAM to the face region A detected from the image data of the original image P1 and thereby detects the face components (see FIG. 6B) such as facial contour and eyes, nose, mouth and eyebrows present inside the facial contour (step S4).

Thereafter, the feature information extracting section 106d extracts the feature information of the respective face component such as the facial contour, eyes, nose, mouth and eyebrows detected by the component detecting section 106c from the face region A of the original image P1 (step S5). Specifically, the feature information extracting section 106d extracts, for example, positional information as the feature information, which is associated with the coordinate positions (x,y) in the x-y plane for pixels forming the facial contour, eyes, nose, mouth, eyebrows and so on.

Then, the face image for replacement specifying section 106e specifies a face image F for replacement that corresponds to the feature information extracted from the face region A of the original image P1 by the feature information extracting section 106d, from among a predetermined number of the face images F for replacement stored in the face image for replacement table T1 (step S6).

Specifically, the face image for replacement specifying section 106e compares respective pieces of the feature information for the predetermined number of the face images F for replacement with respective pieces of the feature information extracted from the face region A of the original image P1, and calculates matching degrees of the face components thereof with each other for the respective face images F for replacement. Then, the face image for replacement specifying section 106e specifies image data of the face image F for replacement (for example, the face image F2 for replacement or the like) that corresponds to the feature information of which the calculated matching degree becomes the highest, reads out the image data from the image storing unit 105, and acquires the same.

Next, based on the feature information of the respective face components in the original image P1, the face image for replacement modifying section 106f sets coordinate positions of pixels configuring the face components as target coordinate positions after modification, and modifies the face image F for replacement so as to move the coordinate positions of the pixels configuring each of the corresponding face components of the face image F for replacement which is specified by the face image for replacement specifying section 106e (step S7).

Subsequently, the replaced image creating section 106g replaces the image of the face region A in the original image P1 with the face image F for replacement modified by the face image for replacement modifying section 106f. Specifically, the replaced image creating section 106g replaces the inner portion of the facial contour of the face region A in the original image P1 with the inner portion of the facial contour of the face image F for replacement, thereby creating the image data for the replaced image P2 (step S8). Then, image data (YUV data) of the replaced image P2 created by the replaced image creating section 106g is acquired by the image storing unit 105 and is stored therein.

Thereafter, the wireless processing unit 109 acquires the replaced image P2 created by the replaced image creating section 106g and transmits the same to the server 2 via the access point AP and the communication network N (step S9).

In the server 2, upon receiving the image data of the transmitted replaced image P2 at the communication processing unit, the image storing unit 105 stores the image data in a predetermined storage region under the control of the central control unit. Then, the server 2 uploads the replaced image P2 on a web page provided on the Internet so that the replaced image P2 becomes published on the Internet.

The image creating process is hereby finished.

As described above, according to the image capturing system 100 of this embodiment, based on the feature information extracted from the face in the original image P1 and the face feature information stored in the image storing unit 105, the replaced image P2 can be created by replacing the image of the face region A in the original image P1 by any of the face images F for replacement stored in the image storing unit 105. Specifically, based on the face feature information stored in the image storing unit 105, the face image F for replacement is specified which corresponds to the feature information extracted from the original image P1, and the replaced image P2 can be created in which the image of the face region A in the original image P1 is replaced by the specified face image.

In other words, taking the feature information extracted from the face in the original image P1 as reference, the face image F for replacement that replaces the face region A can be acquired from the image storing unit 105. This can prevent the face in the face region A in the original image P1 from becoming extremely different before and after the replacement. This means that, even if the face region A in the original image P1 (for example, the face region A of the man in the white coat; see FIG. 6A) is processed through the replacement from the aspect of privacy protection, consistency of the face in the original image P1 and in the replaced image P2 can be secured before and after the replacement.

Accordingly, as compared to a case of directly treating the face in the original image P1 with various types of image processing such as pixelization or blurring, the replaced image with a natural look can be created.

Further, the principal face components are detected from the face of the original image P1 and then from the detected face components, the feature information is extracted; therefore, the face image F for replacement which is to be replaced by the face region A can be acquired by taking, for example, the feature information of the face components such as eyes, nose, mouth, eyebrows, facial contour and the like as reference. Especially, because facial parts such as eyes, nose, mouth and eyebrows have a large effect on facial impression (for example, facial expression of various emotions and the like), the facial impression in the original image P1 can be prevented from becoming extremely different before and after the replacement by specifying the face image F for replacement by taking the facial parts as reference.

Still further, the face image F for replacement is modified based on the feature information of the face components and the modified face image F for replacement thus created is used to replace the image of the face region A in the original image P1; therefore, for example, even in a case where the face images F for replacement stored in the image storing unit 105 only have relatively low matching degrees with the face region A in the original image P1, the face image F for replacement having an improved matching degree with the face region A in the original image P1 can be created. By this, consistency of the face before and after the replacement can be secured, thereby the replaced image P2 with a natural look can be created.

Moreover, the feature information is extracted from the face region A including the face detected from the original image P1, the extraction operation of the feature information from the face region A can be appropriately and simply performed. This allows the face image F for replacement to replace the face region A to be specified appropriately and simply.

In addition, the present invention is not limited to the above embodiment and can be modified variously and altered in design without departing from the scope of the present invention.

Hereinafter, a modification example of the image capturing device 1 is described.

### Modification Example 1

In an image capturing device 301 of the modification example, faces are registered in a predetermined registration unit (for example, an image storing unit 105 or the like), and a replaced image P2 is created by replacing an image of a face region A by a face image F for replacement when the face region A is detected that includes a face not registered in the predetermined registration unit.

Here, apart from the parts to be described below, the image capturing device 301 of the modification example 1 has a substantially similar configuration to the image capturing device 1 of the above embodiment, therefore detailed description is omitted.

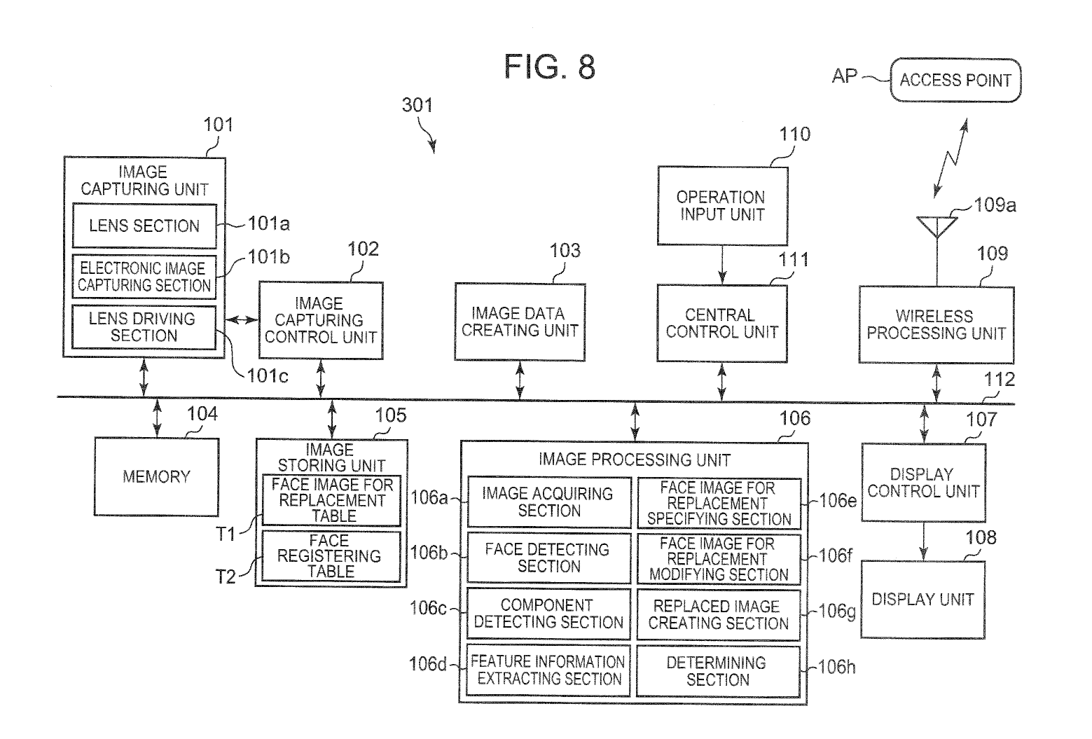

FIG. 8 is a block diagram showing a schematic configuration of the image capturing device 301 of the modification example.

As shown in FIG. 8, an image processing unit 106 of the image capturing device 301 of the modification example includes a determining section 106h in addition to an image acquiring section 106a, a face detecting section 106b, a component detecting section 106c, a feature information extracting section 106d, a face image for replacement specifying section 106e, a face image for replacement modifying section 106f and a replaced image creating section 106g.

The determining section 106h determines whether or not the face of the face region A detected by the face detecting section 106b is a face registered in advance in the image storing unit (registration unit) 105.

In other words, the image storing unit 105 stores a face registering table T2 for registering therein in advance face regions A each of which is excluded from a target to be replaced by the face image F for replacement. The face registering table T2 may have a configuration in which, for example, a face region A is associated with a name of a person upon storing, or only a face region A is stored. For example, in a case of the original image P1 illustrated in FIG. 5, face regions A for three people and a baby, excluding the face region A of a man in a white coat, are respectively registered in the face registering table T2.

Then, when the face regions A in the original image P1 are detected by the face detecting section 106b (see step S2), the determining section 106h determines whether or not the face of the face regions A are the ones registered in the face registering table T2. Specifically, the determining section 106h extracts, for example, feature information from the respective face regions A, and by taking the respective matching degrees as reference, determines whether or not the detected faces of the respective face regions A are the registered ones.

When the determining section 106h determines that any of the faces of the face regions A detected from the original image P1 by the face detecting section 106b is not the registered one, the replaced image creating section 106g replaces the image of the unregistered face region A in the original image P1 by the face image F for replacement to create the replaced image P2.

In other words, the replaced image creating section 106g replaces the image of the unregistered face region A by the face region F for replacement specified by the face image for replacement specifying section 106e (or, the face image F for replacement modified by the face image for replacement modifying section 106f), thereby creating the replaced image P2.

According to the image capturing device 301 of the modification example 1, the image of the concerned face region A is replaced by the face image F for replacement to create the replaced image P2, when the face of the face region A is not the one registered in advance. Therefore, by registering the faces of the face regions A which will not become targets for replacement with the face image F for replacement, that is, the faces having low need for privacy protection, the face region A to be a target for replacement can be specified automatically from among the face regions A detected from the original image P1.

Further, in the above embodiment and the modification example 1, the face image for replacement table T1 in the image storing unit 105 may be provided with representative face image for replacement (not shown), which represent each of groups based on, for example, gender, age, race and the like, and the face region A in the original image P1 is replaced by using this representative face image for replacement. Similarly, the plurality of the face images F for replacement stored in the face image for replacement table T1 in the image storing unit 105 may be grouped based on, for example, gender, age, race and the like and an average representative face image for replacement representing each of the groups is created, to replace the face region A in the original image P1 by this representative face image for replacement.

In other words, a process is performed, for specifying gender, age, race or the like of the face of the face region A detected from the original image P1, and the face region A in the original image P1 is replaced by the representative face image for replacement corresponding to the specified gender, age or race, thereby the replaced image P2 can be created.

In addition, regarding gender, age and race of the face region A in the original image P1, for example, a reference model used in the AAM process may be prepared for each gender, age or race, and the gender, age or race is specified by using the reference model having the highest matching degree with the face region A in the original image P1.

Also, in the above embodiment and the modification example 1, feature information of the principal face components detected from a face in the original image P1 is extracted from the component detecting section 106c; however, it is appropriately changed whether or not to provide the component detecting section 106c, and a configuration may be adopted in which the feature information is directly extracted from the face of the original image P1.

Further, in the above embodiment and the modification example 1, the face region A to be replaced by the face image F for replacement is detected by the face detecting section 106b; however, it is appropriately changed whether or not to provide the face detecting section 106b for performing the face detection process.

Still further, the image of the face region A in the original image P1 which is to become a creation source of the face image F for replacement does not necessarily be the one facing the front. For example, in a case of an image in which the face is inclined to face the diagonal direction, the image is created after being modified so that the face is directed towards the front, and the image may be used in the image creating process. In this case, the face image for replacement which is modified to face the front may be modified back (to face the diagonal direction) upon replacement.

Moreover, the configurations of the image capturing device 1 (301) illustrated in the above embodiment and the modification example 1 are only examples, and not limited to these. Also, although the image capturing device 1 is shown as the image creating device, the configuration is not limited to this, and as long as the image creating process according to the present invention can be executed, any configuration may be adopted.

Still yet further, as a medium readable by a computer for executing each step of the above process, in addition to a ROM, a hard disk or the like, a non-volatile memory such as a flash memory or a portable storage medium such as a CD-ROM may be applied. Also, as a medium for providing program data via the communication line, a carrier wave may be applied.

The embodiments of the present invention are described hereinabove; however, the scope of the present invention is not limited to the above embodiments but aims to include the ones described in the following claims and their equivalents.

The entire disclosure of Japanese Patent Application No. 2012-061686 filed on Mar. 19, 2012 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image creating device comprising:
an acquiring unit for acquiring an image;
an extracting unit for extracting feature information from a face in the image acquired by the acquiring unit; and
a creating unit for creating a replaced image by replacing an image of a face region in the image acquired by the acquiring unit by other image, based on the feature information extracted by the extracting unit.

2. The image creating device according to claim 1, further comprising:
a storage unit for storing at least one face image and feature information for each face after associating the two with each other, wherein
the creating unit creates the replaced image by replacing the image of the face region in the image acquired by the acquiring unit by any one of the face images stored in the storage unit, based on the feature information extracted by the extracting unit and the feature information of the face stored in the storage unit.

3. The image creating device according to claim 1, further comprising:
a component detection unit for detecting principal face components from the face of the image acquired by the acquiring unit, wherein
the extracting unit extracts feature information of the face components detected by the component detection unit.

4. The image creating device according to claim 2, further comprising:
a modifying unit for modifying the face image stored in the storage unit based on the feature information extracted by the extracting unit, wherein
the creating unit creates the replaced image by replacing the image in the face region by a face image modified by the modifying unit.

5. The image creating device according to claim 2, further comprising:
a specifying unit for specifying a face image corresponding to the feature information extracted by the extracting unit, based on the feature information of the face stored in the storage unit, wherein
the creating unit creates the replaced image by replacing the image of the face region by the face image specified by the specifying unit.

6. The image creating device according to claim 1, further comprising:
a face detection unit for detecting the face region including a face from the image acquired by the acquiring unit;
a registration unit for registering a face in advance; and
a determining unit for determining whether or not the face of the face region detected by the face detection unit is the face that is registered in advance in the registration unit, wherein:
the extracting unit extracts feature information from the face region detected by the face detection unit; and
the creating unit creates the replaced image by replacing the image of the face region by other face image, when it is determined by the determining unit that the face in the face region is not the registered face.

7. An image creating method, which uses an image creating device, including:
an acquiring step for acquiring an image;
an extracting step for extracting feature information from a face in the acquired image; and
a creating step for creating a replaced image by replacing an image of a face region in the acquired image by other image, based on the extracted feature information.

8. The image creating method according to claim 7, wherein:
the image creating device further comprises a storage unit for storing at least one face image and feature information for each face after associating the two with each other; and
in the creating step, the replaced image is created by replacing the image of the face region in the image acquired in the acquiring step by any one of the face images stored in the storage unit, based on the feature information extracted in the extracting step and the feature information of the face stored in the storage unit.

9. The image creating method according to claim 7 further including:
a component detecting step for detecting principal face components from the face of the image acquired in the acquiring step, wherein
in the extracting step, feature information is extracted for the face components detected in the component detecting step.

10. The image creating method according to claim 8, further including:
a modifying step for modifying the face image stored in the storage unit based on the feature information extracted in the extracting step, wherein
in the creating step, the replaced image is created by replacing the image in the face region by a face image modified in the modifying step.

11. The image creating method according to claim 8, further including:
a specifying step for specifying a face image corresponding to the feature information extracted in the extracting step, based on the feature information of the face stored in the storage unit, wherein
in the creating step, the replaced image is created by replacing the image of the face region by the face image specified in the specifying step.

12. The image creating method according to claim 7, wherein the image creating device further comprising a registration unit for registering a face in advance, further including:
a face detecting step for detecting the face region including a face from the image acquired in the acquiring step; and
a determining step for determining whether or not the face of the face region detected in the face detecting step is the face that is registered in advance in the registration unit, wherein
in the extracting step, feature information is extracted from the face region detected in the face detecting step; and
in the creating step, the replaced image is created by replacing the image of the face region by other face image, when it is determined in the determining step that the face in the face region is not the registered face.
